(19) United States
(12) Patent Application Publication
(10) Pub. No.: US 2013/0222361 A1
(43) Pub. Date: Aug. 29, 2013

(54) Method for the graphical display of information tailored to the encoding format of the mammalian visual system

(71) Applicant: Philip Meier, Pacific Palisades, CA (US)

(72) Inventor: Philip Meier, Pacific Palisades, CA (US)

(21) Appl. No.: 13/736,066

(22) Filed: Jan. 7, 2013

Related U.S. Application Data
(60) Provisional application No. 61/583,198, filed on Jan. 5, 2012.

(51) Int. Cl. G06T 9/00

(52) U.S. Cl. CPC G06T 9/00
USPC 345/418

(57) ABSTRACT

This is a method for generating static and moving information graphics. The method allows for the novel mapping of raw data to a intermediate format and then associating the intermediate format with graphical features of a visual display. The display features are tailored to the encoding format of visual neurons, including but not limited to the receptive fields of the LGN, V1, V2, MT and MSTd. The utility of the method is to provide a visualization to communicate high dimensional data sets to a human user in a format that has one or more of the following properties: is highly intuitive, maximizes bit rate, supports judgment for a classification task, facilitates outlier detection, emphasizes relevant differences in data sets, and enables visual inference.

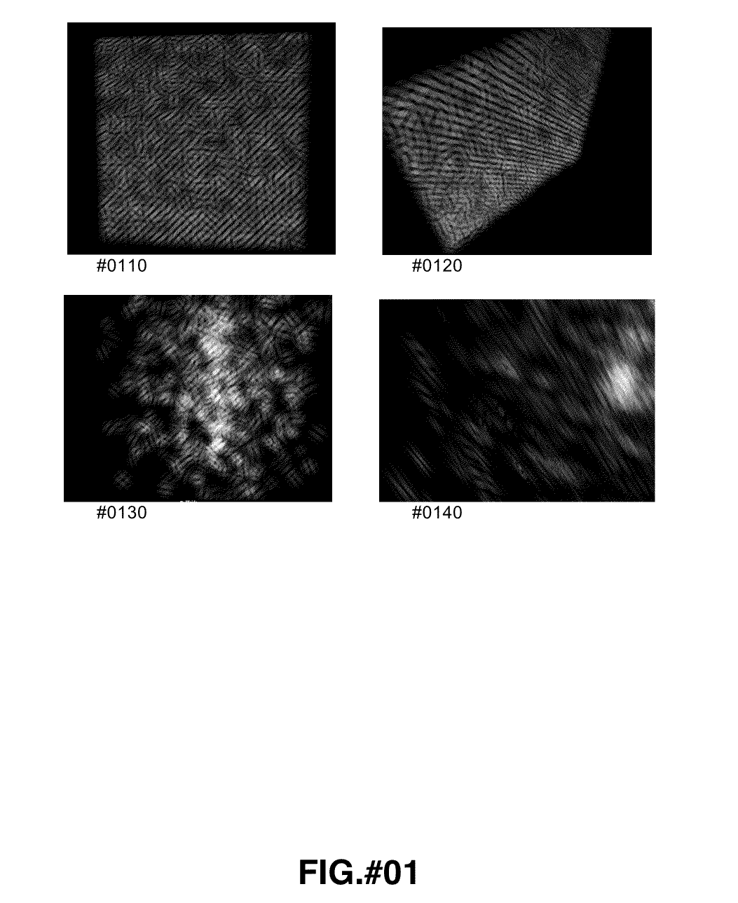

A typical graph may involve data points plotted on an axis. If there are multiple types of data they could be separated by the color or shape of a data point. The method presented here concerns data where each graphical item has many properties, sufficient to the point where displaying all the properties might overwhelm the user and make it difficult to see the relationships in the data.

The method is meant to address the display of data when there are:
many properties per data point
many data points, such that they may overlap

Rather than allowing data points to visually occlude, they summate linearly or sub-linearly. Each pixel is evaluated independently. Each data “point” has a shape. Thus dense regions will have many overlapping properties. The shape of a data point is a two dimensional wavelet, such as a gabor function. These shapes are oriented and bandpass. (Ringach, 2004) This shape is inspired by the capacity of the visual system to represent natural scenes as independent components. (Bell, 1996) Thus, we increase the odds that the visual system can intuitively pick up on complex multi-dimensional features within the data.

### EXAMPLE OF A PARTICULAR EMBODIMENT

Consider the following embodiment, which indicates the point of purchase with a credit card, and summarizes many properties of the transaction. (The data could also be foursquare check-ins, or heart rate monitors, or iPhone accelerometers, twitter posts, or any rich dataset). In this example, space is mapped onto X and Y, but that need not be.

The mapping in this embodiment is as follows:
X-position—latitude
Y-position—longitude
Intensity—cost of purchase
Size—number of items purchased
Orientation—typed primary category (grocery, gas, electronics, etc.)
Aspect ratio—FICO on the credit card
Color polarity—magnitude of purchases on card in last 5 days
RGB of primary color—first three principle components of transaction history
Spatial frequency—constant in this example

### Post Processing

Post processing changes the data so that it better communicates a particular goal. All types of post processing come at a cost. Typically post processing changes the location of data points, thus (slightly) corrupting the meaning of position.

### Post Processing: Repulsive Forces

For example, data points can be treated as particles in an environment with a physics engine. Repulsive forces are then associated between nearby particles, causing them to disperse, but maintain topology. This enables the data to assume a density that is closer to homogenous, but proximity in location is still preserved.

Stronger repulsive forces are applied to data points that were not initially overlapping. The result is that spatially distant data points will still maintain visually detectable gaps. It is as if two cities grew out in suburban sprawl until they almost touched, but a fine boundary was maintained to visually indicate that the suburbs grew from different sources.

### Post Processing: Group by Similarity

Similar features within a region may be grouped together. This process may be mediated in a similar physics environment (attractive forces and Brownian motion), or more explicitly by a local 2D Kohonen map. Again, a regional grouping is desired, so a separate map may be generated for each region. As a result it may be easier to visually assess the relative amounts of different types in a region, by comparing the relative surface area coverage.

### Post Processing: By Constant Ratio

For example, imagine that the purchase of beer is often coupled with lottery tickets. This relationship can be revealed by explicitly paring the visual relation between two items. In other words, a “beer purchase” (with a particular visual appearance) would bind to a “lottery ticket” purchase (also with a particular and appearance), and a fixed angular and spatial offset. As a result, the region with both of these items will take on a more homogenous texture. The reason for this is the visual systems sensitivity to correlations of such spatially offset oriented items. (Portilla, 2000)

### Post Processing: Push Type to Lattice

Again, this allows for a repeated structure to be created by effecting the potion of the data points. Thus violations of the structure are more easily detected. This is particularly useful with constant ratio binding because it makes it easier to detect the repeated correlation when the items are within a periodic lattice. A threshold is set such that a data point will not snap to lattice if greater than N periods away from its original location.

### Interface to Create New Mappings

To achieve this mapping some domain expertise was used, both of knowledge of credit transaction and of salient visual features. For a new user to use the system it is helpful to rapidly consider different mappings. This invention also claims an interface (controlled via web or software app), that controls rapidly updating graphical image either on the same display or a remote viewing surface. The data is pulled from a database, and processed either remotely in the cloud or locally on the device at hand. The user selects an available graphical feature (left hand column above) and maps it to an available data feature (right hand column above). Next the user applies post processing rules to the different feature types.

### System to Validate a Mapping

The invention also claims a system that can rapidly display new data sets and require a user to make business decisions on the basis of the information. In this fashion is is possible to empirically validate that a particular mapping is the most effective and communicating the information for the decision. Available tasks include:
Does any image in a sequence of N contain an abnormal feature? (yes/no)
Which data set corresponds to a better business outcome? (2-way force choice)
What domain is changing most? (N-way force choice) In what way? (radio button)

### Method to Construct Event Data

There are times when it is desirable to represent analog value as events. In this case a detector is constructed to identify patterns in a steam of data. A pattern may consist of above threshold value of the data (or a transform of the data) projected onto a hyper-plane. For example, an “event” may be a rise in the price of one stock coupled with a decrease in trading volume. These would then be plotted in a graph of time on the x-axis and a one dimensional Kohonen map of topic on the y-axis.

### Application to Motion

Additional values may be applied to wavelets:
phase drift speed
drift direction
position change

Motion patterns related to global flow fields may also be applied as additional features. The inspiration of these types come from the receptive fields of MSTd and may be related to a basis set of flow fields from visual navigation (Parkt, 2000).

### REFERENCES

J Portilla and E P Simoncelli. “A Parametric Texture Model based on Joint Statistics of Complex Wavelet Coefficients.” Int'l Journal of Computer Vision. 40(1):49-71, October, 2000
Ringach D L. “Mapping receptive fields in primary visual cortex.” J Physiol. 558(Pt 3):717-28 (2004).
Bell A. J. and Sejnowski T. J. 1996.“Edges are the ‘independent components’ of natural scenes”, Advances in Neural Information Processing Systems 9, MIT press.
Parkt K, Jabrit A, Sejnowski T “Independent Components of optical flows have MSTd-like receptive fields” Proceedings of the 2nd International Workshop on ICA and Blind Signal Separation. Helsinki, Finland 597-601 (2000)

1. A method of displaying samples of a dataset as an image or video, comprising a mapping one or more samples to a plurality of graphical objects, each having a degree of transparency and a degree of overlap relative to each other; and by mapping at least one attributes of the samples to a property of the graphical objects that remains visually discernable despite any transparency or any overlap; and by grouping the graphical objects in a spatial relationship that indicates a similarity of the underlying samples.

2. The method of claim 1, wherein the spatial relationships are selected to preserve one or more of the following:
a proximity to other similar samples,
an amount of overlap of nearest samples,
a proximity to a regular geometric grid of nearby samples, or
a spatial offset to nearby samples.
